(19) United States
(12) Patent Application Publication
(10) Pub. No.: US 2012/0295620 A1
(43) Pub. Date: Nov. 22, 2012

(54) ADVANCED LEGACY MOBILE STATION DOMAIN (ALMSD) INTERSYSTEM HANDOFF WITHOUT ANCHOR NETWORK BEARER SUPPORT

(76) Inventors: Gary Stephens, Richardson, TX (US); Marvin Bienn, Dallas, TX (US)

(21) Appl. No.: 13/218,526

(22) Filed: Aug. 26, 2011

Related U.S. Application Data
(60) Provisional application No. 61/488,343, filed on May 20, 2011.

(51) Int. Cl. H04W 36/00

(52) U.S. Cl. 455/436

(57) ABSTRACT

A method for intersystem handoff of a Mobile Station (MS) from an Anchor Mobile Switching Center emulation (MSCe) to a Target MSCe that both support Advanced Legacy Mobile Station Domain (ALMSD), wherein the MS is in communication with a B-Party. The Anchor MSCe sends a handoff request to the Target MSCe to allocate resources for a connection between the MS and an identified Target BS and to establishes bearer resources in a Target Media Gateway (MGW) and in the Target BS to support a voice bearer path between the Target BS and the B-Party. The Anchor MSCe instructs the MS when to move to the Target BS and upon a successful connection to the Target BS, the Anchor MSCe establishes a voice bearer path between the Target BS and the B-Party without maintaining any anchor network bearer resources. The Anchor MSCe completes the handoff by releasing resources in the Anchor BS.

### CROSS-REFERENCE TO RELATED APPLICATIONS

This application claims the benefit of U.S. Provisional Application No. 61/488,343 filed May 20, 2011, the disclosure of which is incorporated by reference herein in its entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND

The present invention relates to cellular telecommunication systems. More particularly, and not by way of limitation, the present invention is directed to an apparatus and method for intersystem handoff between an Anchor MSCe and a Target MSCe that both support Advanced Legacy Mobile Station Domain (ALMSD), which allows for the removal of anchor network bearer resources upon the successful completion of the intersystem handoff.

Code Division Multiple Access (CDMA) voice services such as call connection to a mobile station are supported by establishing a signaling and bearer connection between a Mobile Station (MS), a Base Station (BS), and a Mobile Switching Center (MSC). The BS controls the air interface resources and the MSC performs call control for the voice services provided to the MS. If the MS is moving, the signal strength between the MS and the BS may decrease to the point that a different BS becomes better able to establish a signaling and bearer connection to the MS due to a higher signal strength. A handoff, or handover, occurs when the air interface resources supporting an ongoing voice service are transferred from an anchor BS (the BS initiating the handoff) to a target BS (the BS receiving the handoff request). An intra-MSC handoff occurs when both the anchor BS and the target BS are served by the same MSC. An inter-MSC (i.e., intersystem) handoff occurs when the anchor BS and the target BS are served by different MSCs.

A Mobile Switching Center emulation (MSCe) is a network entity originally defined for Legacy MS Domain (LMSD) support. The MSCe provides signaling capabilities comparable to those of a legacy MSC but has only bearer management capabilities. Some of the MSCe functionality includes:
a. the establishment, management, and release of voice calls and bearer resources associate with a voice call (for example, the use of Session Initiation Protocol (SIP) signaling for call control and the use of H.248 signaling to control bearer resource allocation);
b. call modifications for ongoing voice calls (for example, call hold, the addition of a third party to the call, the redirection of the call to a different party); and
c. interworking between the TIA/EIA-41 signaling protocol and the SIP signaling protocols.

For intersystem handoff communications between an Anchor MSCe and a Target MSCe that both support Legacy Mobile Station Domain (LMSD) the TIA/EIA-41 signaling protocol and the SIP signaling protocol are required. For intersystem handoff communications between an Anchor MSCe and a Target MSCe that both support Advanced Legacy Mobile Station Domain (ALMSD) only the SIP signaling protocol is required. If the Anchor MSCe and a Target MSCe both support Advanced Legacy Mobile Station Domain (ALMSD) no Signaling System 7 (SS7) connectivity is required between the two MSCes

The MSCe controls bearer resources using H.248 signaling to a Media Gateway (MGW). The MGW has the ability to connect to the IP-based core network as well as to the circuit-based Public Switched Telephone Network (PSTN). The MGW may provide vocoding and/or transcoding functions to the bearer traffic. The resources provided by the MGW, including transcoding resources, can be used to support bearer channels that are contained entirely within the IP environment.

### SUMMARY

A problem with the existing solution for an intersystem handoff between an Anchor MSCe and a Target MSCe is that there is no existing solution that enables the voice bearer path to the Target BS to be established without maintaining Anchor MGW bearer resources in the voice bearer path.

The present invention provides a solution to the above-mentioned problem. In one embodiment, the Anchor MSCe is provided with the ability to establish a voice bearer path between the B-Party and the Target BS that does not include Anchor MGW bearer resources. This results in less equipment and therefore lower cost to support the voice call.

In one embodiment, the present invention is directed to a method for intersystem handoff of a Mobile Station (MS) from an Anchor MSCe to a Target MSCe, wherein the MS is in communication with a B-Party. The method includes the steps of the Anchor MSCe sending a request to the Target MSCe to allocate resources for a connection between the MS and a Target BS associated with the Target MSCe; the Target MSCe establishing bearer resources in a Target MGW and in the Target BS to support a voice bearer path between the Target BS and the B-Party; and the Anchor MSCe instructing the MS to move to the Target BS. The method also includes the Anchor MSCe establishing the voice bearer path between the Target BS and the B-Party that does not include Anchor MGW bearer resources; and the Anchor MSCe releasing resources for a connection between the MS and an Anchor BS.

In another embodiment, the present invention is directed to an Anchor MSCe for supporting an intersystem handoff of an MS from the Anchor MSCe to a Target MSCe, wherein the MS is in communication with a B-Party. The Anchor MSCe includes a Target MSCe message interface configured to send to the Target MSCe, a handoff request that includes an identifier of a Target BS, wherein the handoff request causes the Target MSCe to establish bearer resources in a Target MGW and in the Target BS to support a voice bearer path between the B-Party and the Target BS, the bearer resources including a first connection in the Target MGW towards the B-Party and a second connection in the Target MGW towards the Target BS. The Target MSCe message interface is also configured to send to the Target MSCe, an instruction to place the first connection for the voice bearer path in the Target MGW on hold. The Anchor MSCe also includes an Anchor BS message interface configured to send an instruction to the MS to move to the Target BS, and when the handoff is complete, to instruct the Anchor BS to releases resources for a connection between the MS and the Anchor BS. The Anchor MSCe also includes a B-Party message interface configured to solicit a Session Description Protocol (SDP) offer/answer exchange between the B-Party and the Target MGW to establish the voice bearer path between the B-Party and the Target BS, wherein the voice bearer path does not include Anchor MGW bearer resources.

In another embodiment, the invention is directed to a Target MSCe for supporting an intersystem handoff of an MS from an Anchor MSCe to the Target MSCe, wherein the MS is in communication with a B-Party. The Target MSCe includes an Anchor MSCe message interface configured to receive a handoff request from the Anchor MSCe that includes an identifier of a Target BS; and a Target BS message interface configured to send an instruction to the Target BS to establish bearer resources in the Target BS to support a voice bearer path between a Target MGW and the Target BS, and to allocate air interface resources to establish a connection between the Target BS and the MS. The Target MSCe also includes a Target MGW message interface configured to send an instruction to the Target MGW to establish bearer resources in the Target MGW to support the voice bearer path between the B-Party and the Target BS, the bearer resources in the Target MGW including a first connection in the Target MGW towards the B-Party and a second connection in the Target MGW towards the Target BS; wherein the Anchor MSCe message interface is also configured to receive a request from the Anchor MSCe to place the Target MGW resources in a hold state, and subsequently to receive a request from the Anchor MSCe to place the Target MGW resources in an active state and to instruct the Target MGW resources to set up a bearer connection to the B-Party; and wherein the Target BS message interface is also configured to send to the Target BS, information regarding the second connection at the Target MGW towards the Target BS.

Compared to the existing solution for intersystem handoff between an Anchor MSCe and a Target MSCe, the present invention uses less equipment (no anchor network bearer resources), and significantly reduces the complexity of the intersystem handoff process when both the Anchor MSCe and the Target MSCe support ALMSD. Support for ALMSD, that is the use of only SIP signaling between the Anchor MSCe and the Target MSCe for intersystem communications, implies 1) fewer network timers are required; 2) the scenario where both the TIA/EIA-41 intersystem handoff request and the SIP intersystem handoff request message must both be received before the Target MSCe can start establishing bearer resources is eliminated; 3) many fault conditions no longer occur (e.g., getting one message and not the other); and 4) the scenario where one of the intersystem handoff request messages is properly formatted but the other is not is eliminated,

### BRIEF DESCRIPTION OF THE DRAWINGS

In the following section, the invention will be described with reference to exemplary embodiments illustrated in the figures, in which:

FIG. 1 is a signaling diagram illustrating an exemplary embodiment of the method of the present invention;

FIG. 2 is a simplified block diagram of an Anchor MSCe in an exemplary embodiment of the present invention;

FIG. 3 is a simplified block diagram of a Target MSCe in an exemplary embodiment of the present invention; and

FIG. 4 is a flow chart of an exemplary embodiment of the method of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention. Additionally, it should be understood that the invention may be implemented in hardware or in a combination of hardware and software in which one or more processors execute computer program instructions stored on non-transitory memory devices, and thereby cause the various nodes in the Anchor and Target Networks to perform the inventive method.

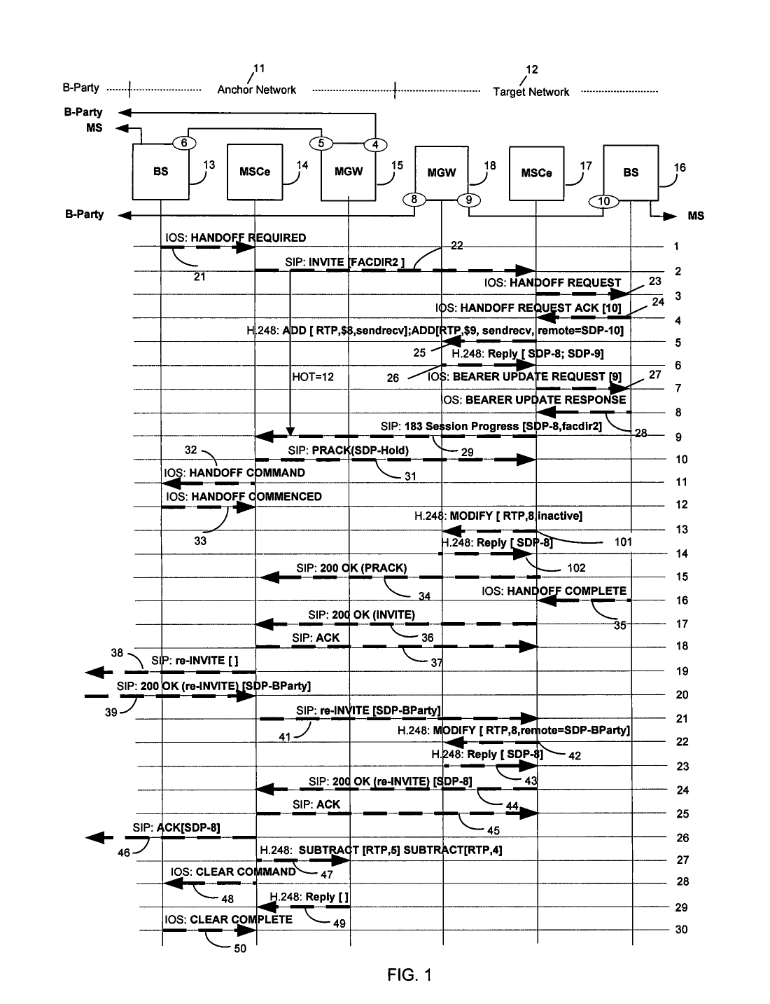

FIG. 1 is a signaling diagram illustrating an exemplary embodiment of the method of the present invention. The illustrated scenario shows an intersystem handoff from an Anchor Network 11 to a Target Network 12. The Anchor Network includes an Anchor BS 13, an Anchor MSCe 14, and an Anchor MGW 15. The Target Network includes a Target BS 16, a Target MSCe 17, and a Target MGW 18. Both the Anchor MSCe 14 and the Target MSC 15 support Advanced LMSD. The signaling diagram assumes that a media exchange is already established between an MS in the Anchor Network and a party with whom the MS is communicating served in another network/system. IP connections at the MGW and BS are illustrated as numbers inside small ovals. The voice bearer path of the initial media exchange is illustrated here in folded fashion using the oval numbers (B-Party)->(4)(5)->(6)->(MS). The term “B-Party” is used herein to denote the network entity that sent the original call request to the Anchor MSCe 14 to establish a call with the MS (e.g., the B-Party could be another MS or an MSCe supporting the MS originating the initial call request).

When it is determined that an Intersystem Handoff is necessary between the Anchor Network 11 and the Target Network 12, the serving Anchor BS 13 sends an Inter-Operability Specification (IOS) HANDOFF REQUIRED message 21 to the Anchor MSCe 14 and includes in the message, a list of candidate cells in the domain of Target BS 16. In response, the Anchor MSCe 14 sends a SIP INVITE message 22 to the Target MSCe 17. The SIP INVITE message contains a TIA/EIA-41 Facility Directive (FACDIR2) INVOKE (concisely indicated as FACDIR2) message as part of the SIP message body. The FACDIR2 INVOKE message contains the list of candidate cells and the identity of Target BS 16 received in the IOS HANDOFF REQUIRED message 21. Upon receiving the SIP INVITE message 22 containing the FACDIR2, the Target MSCe 17 sends an IOS HANDOFF REQUEST message 23 to the Target BS 16. In this case, the HANDOFF REQUEST is used to trigger an offer of BS capabilities at the Target BS.

The Target BS 16 responds by sending an IOS HANDOFF REQUEST ACK message 24 to the Target MSCe 17, and includes in the HANDOFF REQUEST ACK message, an IP address and codec capabilities for the connection in the Target BS 16 (indicated by the oval 10). Upon receiving the IOS HANDOFF REQUEST ACK message, the Target MSCe 17 sends an International Telecommunication Union Telecommunication (ITU-T) H.248 message 25 containing two ADD commands to the Target MGW 18 requesting the establishment of two connections (indicated by the ovals 8 and 9). The first ADD command establishes a first connection (8) towards the B-Party using real-time transport protocol (RTP), and the second ADD command establishes a second connection (9) from the Target MGW 18 towards the Target BS 16 also using RTP. The Target MGW responds by sending Session Description Protocol (SDP) information for the two connections to the Target MSCe 17 in an H.248 Reply message 26. The Target MSCe then sends an IOS BEARER UPDATE REQUEST message 27 to the Target BS 16 with the Target MGW 18 IP address and a selected codec. The Target BS responds by sending an IOS BEARER UPDATE RESPONSE message 28 to the Target MSCe 17.

Upon receiving the SDP information in the H.248 Reply message 26, the Target MSCe 17 also sends a SIP 183 Session Progress message 29 to the Anchor MSCe 14 and includes an SDP offer containing the address (for example, IP address) and codec(s) for the Target MGW 18 connection (oval 8) and the TIA/EIA-41 FACDIR2 RETURN RESULT (concisely indicated as facdir2) in the SIP 183 Session Progress message 29 body. Following the receipt of the 183 Session Progress message from the Target MSCe, the Anchor MSCe 14 sends a SIP Provisional Response Acknowledgment (PRACK) message 31 to the Target MSCe 17 and includes an SDP answer that results in Target MGW connection 8 going into a hold state (e.g. an SDP answer with the media steam attribute set to “inactive”).

At any time after receipt of the FACDIR2 RETURN RESULT in the 183 Session Progress message 29, the Anchor MSCe 14 sends an IOS HANDOFF COMMAND message 32 to the Anchor BS 13. This triggers the Anchor BS to send a Handoff Direction Message to the MS instructing the MS to establish a connection with the Target BS 16. The Anchor BS 13 sends an IOS HANDOFF COMMENCED message 33 to the Anchor MSCe 14 to notify the Anchor MSCe that the MS has been ordered to move to the Target BS 16 channel.

The Target MSCe 17, in response to the SDP answer in the SIP PRACK message 31, sends an H.248 message 101 containing a MODIFY command to Target MGW 18 instructing Target MGW 18 to place connection (8) into an inactive state. The Target MGW 18 acknowledges the results of the H.248 message 101 with an H.248 Reply message 102 containing SDP information for connection (8). In response to the SIP PRACK message 31, the Target MSCe 17 sends a SIP 200 OK (PRACK) 34 to the Anchor MSCe 14. When the MS has successfully established a connection with Target BS 16, the Target BS sends an IOS HANDOFF COMPLETE message 35 to the Target MSCe 17. The Target MSCe sends a SIP 200 OK (INVITE) message 36 to the Anchor MSCe 14 to indicate that the MS has successfully established a connection to Target BS 16. At this time, a voice bearer channel from the MS to the Target BS 16 to Target MGW 18 connection 9 has been established. The Anchor MSCe 14 sends a SIP ACK message 37 to the Target MSCe 17 in response to the SIP 200 OK (INVITE) message 36.

Knowing that the MS has successfully established a connection to Target BS 16, the Anchor MSCe 14 sends a SIP re-INVITE message 38 to the B-Party. The SIP re-INVITE message does not contain an SDP offer. In response to the SIP re-INVITE message, the Anchor MSCe 14 receives from the B-Party, a SIP 200 OK (re-INVITE) message 39 containing an SDP offer. The Anchor MSCe then sends a SIP re-INVITE message 41 to the Target MSCe 17. The SIP re-INVITE message 41 contains the SDP offer received in the SIP 200 OK (re-INVITE) message 39. Following receipt of the SIP re-INVITE message 41 from the Anchor MSCe, the Target MSCe sends an H.248 message 42 containing a MODIFY command to the Target MGW 18 to update the bearer information at the Target MGW based upon the SDP offer, thereby releasing the voice bearer path from the inactive state and pairing the connection (8) with the B-Party. The Target MGW 18 acknowledges the results of the H.248 MODIFY command with an H.248 Reply message 43 containing SDP information for connection (8). The Target MSCe 17 sends the Anchor MSCe 14 a SIP 200 OK (re-INVITE) message 44 containing an SDP answer (which is the SDP information received in the H.248 Reply message 43) in response to the SIP re-INVITE message 41. The Anchor MSCe sends a SIP ACK message 45 to the Target MSCe in response to the SIP 200 OK (re-INVITE) message 44.

Upon receiving the SDP answer in the a SIP 200 OK (re-INVITE) message 44, the Anchor MSCe 14 sends a SIP ACK message 46 to the B-Party in response to the SIP 200 OK (re-INVITE) message 39. The SIP ACK message 46 contains an SDP answer (which is the SDP information received in the H.248 Reply message 43) to the SDP offer received in the SIP 200 OK (re-INVITE) message 39.

At any time after receipt of the SIP 200 OK (INVITE) message 36 from the Target MSCe 17, the Anchor MSCe 14 sends an H.248 message 47 containing two SUBTRACT commands to the Anchor MGW 15. The first SUBTRACT command removes connection 5, which was associated with the bearer path to the Anchor BS 13, and the second SUBTRACT command removes connection 4, which was associated with the bearer path to the B-Party. Also at any time after receipt of the SIP 200 OK (INVITE) message 36 from the Target MSCe, the Anchor MSCe sends an IOS CLEAR COMMAND message 48 to the Anchor BS 13. The Anchor MGW 15 acknowledges the H.248 message 47 containing two SUBTRACT commands with an H.248 Reply message 49. The Anchor BS responds to the IOS CLEAR COMMAND 48 by sending an IOS CLEAR COMPLETE message 50 to the Anchor MSCe 14.

Thus, in a novel manner, the Anchor MSCe 14 never establishes any IP connections in Anchor MGW 15, resulting in no Anchor MGW 15 resources supporting the voice bearer path after the intersystem handoff is complete. While in prior art methods, IP connections are established in the Anchor MGW 15 before Anchor MSCe 14 sends an initial handoff request (e.g., SIP INVITE message 22) to Target MSCe 17, in the present invention the Anchor MSCe 14 removes the Anchor MGW 15 from the voice bearer path. In the embodiment of FIG. 1, this is performed with messages 38-45, where the Anchor MSCe soliciting an SDP offer/answer exchange between the B-Party and Target MGW 18 for establishing the voice bearer path.

Since the Anchor MSCe 14 never establishes any IP connections in Anchor MGW 15 for supporting the voice bearer path, the IP connection 8 in Target MGW 18 towards the B-Party must be placed in an inactive (or hold) state until after the Anchor MSCe has been notified that the MS has successfully connected to the Target BS 16 (indicated by the SIP 200 OK (INVITE) message 36) and the Anchor MSCe 14 has solicited an SDP offer from the B-Party (SIP re-INVITE message 38 and SIP 200 OK message 39) and sent the B-Party SDP offer via the Target MSCe to Target MGW 18 (indicated by SIP re-INVITE message 41 and H.248 message 42). This implies that the Anchor MSCe 14 may reply to the SDP offer received from the Target MSCe 17 in the 183 Session Progress message 29 by sending an SDP answer with the media stream set to “inactive” in the SIP PRACK message 31. This enables connection 8 at the Target MGW 18 to stay connected while placed in a hold state.

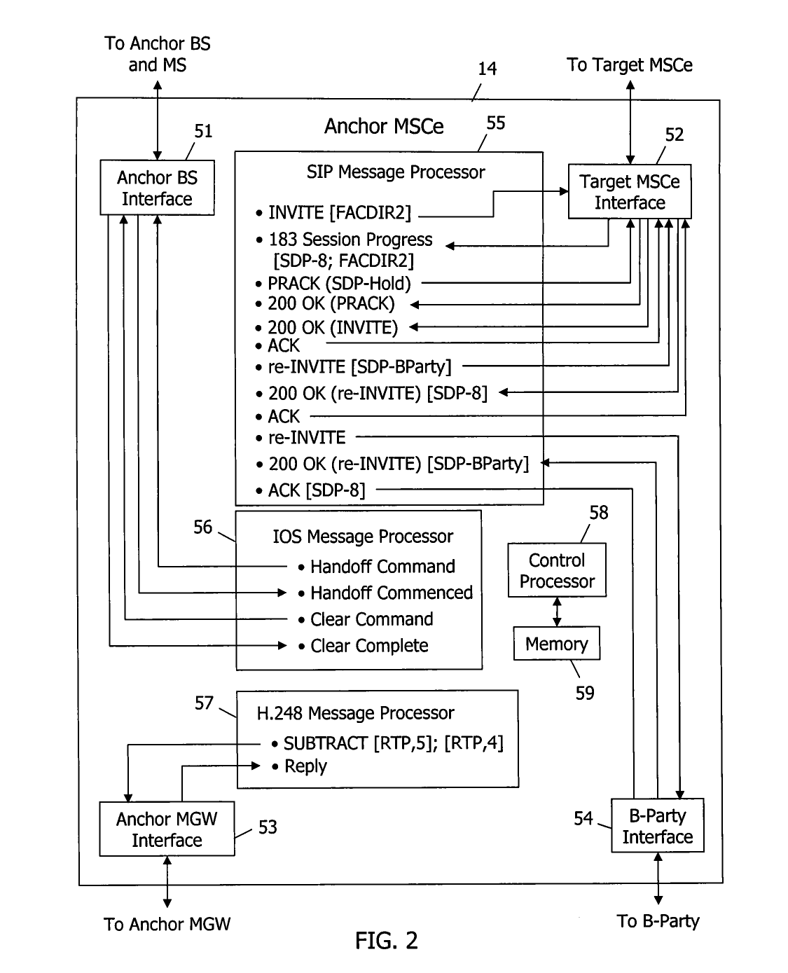

FIG. 2 is a simplified block diagram of the Anchor MSCe 14 in an exemplary embodiment of the present invention. In this embodiment, the Anchor MSCe includes an Anchor BS Interface 51, a Target MSCe Interface 52, an Anchor MGW Interface 53, and a B-Party Interface 54. The Anchor MSCe also includes a SIP Message Processor 55, an IOS Message Processor 56, and an H.248 Message Processor 57. It should be understood that the Anchor MSCe may be implemented in hardware or in a combination of hardware and software in which one or more processors, such as Control Processor 58, execute computer program instructions stored on non-transitory memory devices, such as Memory 59. The Control Processor causes the components of the Anchor MSCe to prepare, send, receive, and respond to the various messages while performing the method of FIG. 1.

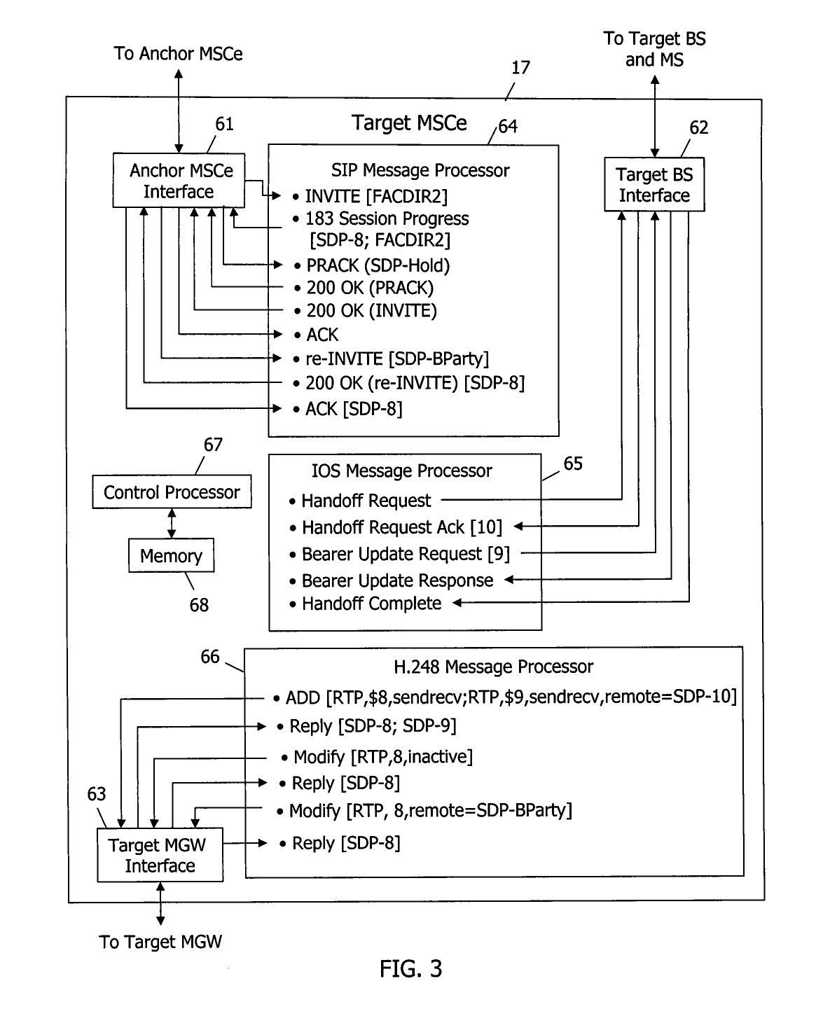

FIG. 3 is a simplified block diagram of the Target MSCe 17 in an exemplary embodiment of the present invention. In this embodiment, the Target MSCe includes an Anchor MSCe Interface 61, a Target BS Interface 62, and a Target MGW Interface 63. The Target MSCe also includes a SIP Message Processor 64, an IOS Message Processor 65, and an H.248 Message Processor 66. It should be understood that the Target MSCe may be implemented in hardware or in a combination of hardware and software in which one or more processors, such as Control Processor 67, execute computer program instructions stored on non-transitory memory devices, such as Memory 68. The Control Processor causes the components of the Target MSCe to prepare, send, receive, and respond to the various messages while performing the method of FIG. 1.

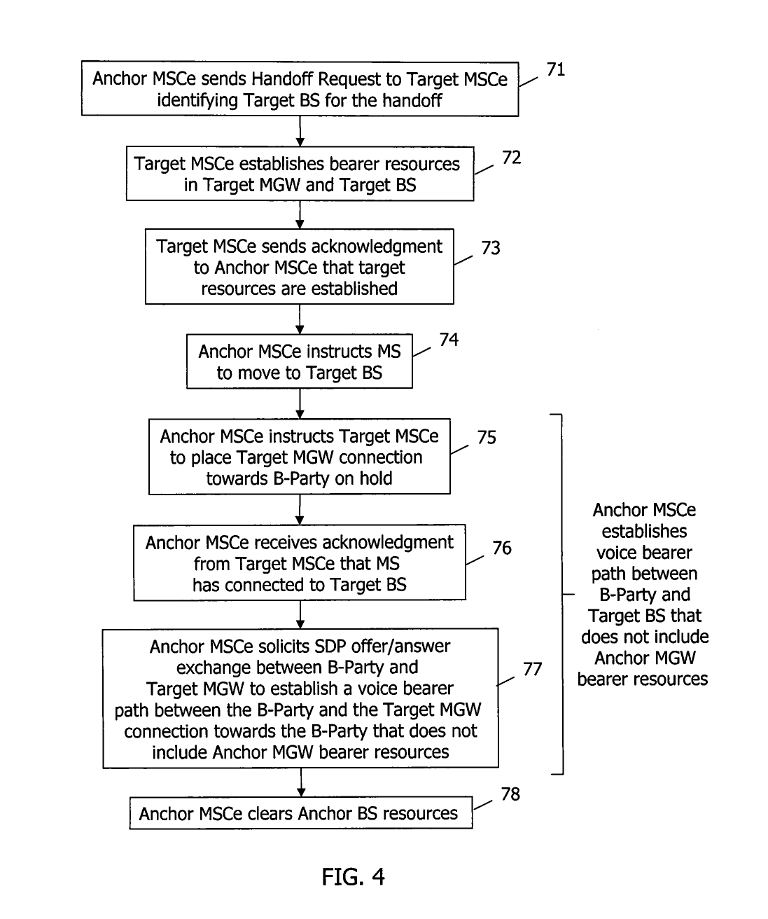

FIG. 4 is a flow chart of an exemplary embodiment of the method of the present invention. At step 71, the Anchor MSCe 14 sends a handoff request to the Target MSCe 17 identifying the Target BS 16 for the handoff. As shown in FIG. 1, this may be done by sending the SIP INVITE message 22 containing the FACDIR2 INVOKE message. At step 72, the Target MSCe establishes bearer resources in the Target MGW 18 and the Target BS to support a voice bearer path. At step 73, the Target MSCe sends an acknowledgment to the Anchor MSCe indicating that the target bearer resources have been established. At step 74, the Anchor MSCe instructs the MS to move to the Target BS 16.

Step 75 begins a series of steps through which the Anchor MSCe 14 establishes a voice bearer path between the B-Party and the Target BS 16 that does not include Anchor MGW bearer resources. At step 75, the Anchor MSCe instructs the Target MSCe 17 to place the Target MGW connection (8) towards the B-Party on hold. At step 76, the Anchor MSCe receives an acknowledgment from the Target MSCe that the MS has connected to the Target BS. This also implies that bearer resources between the MS and Target MGW connection (9) has been established. At step 77, the Anchor MSCe 14 solicits an SDP offer/answer exchange between the B-Party and the Target MGW 18 to establish a voice bearer path between the B-Party and the Target MGW connection (8) that does not include Anchor MGW bearer resources. Upon a successful SDP offer/answer exchange the voice bearer path between the B-Party and the MS is now established. At step 78, the Anchor MSCe 14 releases resources for the connection between the MS and the Anchor BS 13 to complete the handoff.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

1. A method for intersystem handoff of a Mobile Station (MS) from an Anchor Mobile Switching Center emulation (MSCe) to a Target MSCe in a Code Division Multiple Access (CDMA) cellular network, wherein the MS is in communication with a B-Party, the method comprising the steps of:
the Anchor MSCe sending a request to the Target MSCe to allocate resources for a connection between the MS and a Target Base Station (BS) associated with the Target MSCe;
the Target MSCe establishing bearer resources in a Target Media Gateway (MGW) and in the Target BS to support a voice bearer path between the Target BS and the B-Party;
the Anchor MSCe instructing the MS to move to the Target BS;
the Anchor MSCe establishing the voice bearer path between the Target BS and the B-Party that does not include Anchor MGW bearer resources; and
the Anchor MSCe releasing resources for a connection between the MS and an Anchor BS.

2. The method as recited in claim 1, wherein the step of the Anchor MSCe sending a request to the Target MSCe includes sending a Session Initiation Protocol (SIP) INVITE message that contains a Facilities Directive (FACDIR2) message.

3. The method as recited in claim 2, wherein the Facilities Directive (FACDIR2) message includes an identifier of the Target BS.

4. The method as recited in claim 1, wherein the step of the Target MSCe establishing the bearer resources in the Target MGW includes the steps of:
sending from the Target MSCe to the Target MGW, an ADD command requesting two connections, a first connection to be paired with the bearer path towards the B-Party, and a second connection to be paired with the Target BS; and
sending from the Target MSCe to the Anchor MSCe, an address and codec for the first connection in the Target MGW.

5. The method as recited in claim 4, further comprising sending from the Target MSCe to the Target BS, an address and codec for the second connection in the Target MGW.

6. The method as recited in claim 4, further comprising the steps of:
sending from the Anchor MSCe to the Target MSCe, a provisional response acknowledgment message in response to receiving the address and codec for the first connection in the Target MGW, the provisional response acknowledgment message containing a Session Description Protocol (SDP) instruction for the Target MSCe to place the first connection in the Target MGW in a hold state;
the Target MSCe placing the first connection in the Target MGW in the hold state until the Anchor MSCe has solicited an SDP offer from the B-Party; and
the Anchor MSCe forwarding the SDP offer from the B-Party to the Target MGW via the Target MSCe to release the first connection from the hold state.

7. The method as cited in claim 1, wherein the step of the Anchor MSCe releasing the resources for a connection between the MS and the Anchor BS includes the steps of:
sending an Interoperability Specification (IOS) CLEAR COMMAND message to the Anchor BS; and
receiving an Interoperability Specification (IOS) CLEAR COMPLETE message from the Anchor BS.

8. An Anchor Mobile Switching Center emulation (MSCe) for supporting an intersystem handoff of a Mobile Station (MS) from the Anchor MSCe to a Target MSCe in a Code Division Multiple Access (CDMA) cellular network, wherein the MS is in communication with a B-Party, the Anchor MSCe comprising:
a Target MSCe message interface configured to send to the Target MSCe, a handoff request that includes an identifier of a Target Base Station (BS), wherein the handoff request causes the Target MSCe to establish bearer resources in a Target Media Gateway (MGW) and in the Target BS to support a voice bearer path between the B-Party and the Target BS, the bearer resources including a first connection in the Target MGW towards the B-Party and a second connection in the Target MGW towards the Target BS;
an Anchor BS message interface configured to send an instruction to the MS to move to the Target BS;
wherein the Target MSCe message interface is also configured to send to the Target MSCe, an instruction to place the first connection for the voice bearer path in the Target MGW on hold;
a B-Party message interface configured to solicit a Session Description Protocol (SDP) offer/answer exchange between the B-Party and the Target MGW to establish the voice bearer path between the B-Party and the Target BS, wherein the voice bearer path does not include Anchor MGW bearer resources; and
wherein the Anchor BS message interface is also configured to instruct the Anchor BS to releases resources for a connection between the MS and the Anchor BS.

9. The Anchor MSCe as recited in claim 8, wherein the Anchor MSCe includes a control processor adapted to cause the Anchor MSCe to:
receive from the Target MSCe, an address and codec for the first connection in the Target MGW; and
send from the Anchor MSCe to the Target MSCe, a provisional response acknowledgment message in response to receiving the address and codec for the first connection, the provisional response acknowledgment message containing an SDP indication to place the first connection in the Target MGW for the voice bearer path in a hold state.

10. The Anchor MSCe as recited in claim 9, wherein sending the provisional response acknowledgment message containing the SDP indication places the first connection in the Target MGW for the voice bearer path in the hold state until after the Anchor MSCe has solicited the SDP offer/answer exchange between the B-Party and the Target MGW, and the control processor also causes the Anchor MSCe to:
solicit and receive the SDP offer from the B-Party; and
forward the SDP offer to the Target MGW via the Target MSCe to release the connection for the voice bearer path from the hold state.

11. A Target Mobile Switching Center emulation (MSCe) for supporting an intersystem handoff of a Mobile Station (MS) from an Anchor MSCe to the Target MSCe in a Code Division Multiple Access (CDMA) cellular network, wherein the MS is in communication with a B-Party, the Target MSCe comprising:
an Anchor MSCe message interface configured to receive a handoff request from the Anchor MSCe that includes an identifier of a Target Base Station (BS);
a Target BS message interface configured to send an instruction to the Target BS to establish bearer resources in the Target BS to support a voice bearer path between a Target Media Gateway (MGW) and the Target BS, and to allocate air interface resources to establish a connection between the Target BS and the MS;
a Target MGW message interface configured to send an instruction to the Target MGW to establish bearer resources in the Target MGW to support a voice bearer path between the B-Party and the Target BS, the bearer resources in the Target MGW including a first connection in the Target MGW towards the B-Party and a second connection in the Target MGW towards the Target BS;
wherein the Anchor MSCe message interface is also configured to receive a request from the Anchor MSCe to place the Target MGW resources in a hold state, and subsequently to receive a request from the Anchor MSCe to place the Target MGW resources in an active state and to instruct the Target MGW resources to set up a bearer connection to the B-Party without including an Anchor MGW in the voice bearer path; and
wherein the Target BS message interface is also configured to send to the Target BS, information regarding the second connection at the Target MGW towards the Target BS.

12. The Target MSCe as recited in claim 11, wherein the request for the Anchor MSCe to place the Target MGW resources in a hold state is a Session Initiation Protocol (SIP) Provisional Response Acknowledgment (PRACK) message containing a Session Description Protocol (SDP) indication that an associated media stream should be set to inactive.

13. The Target MSCe as recited in claim 11, wherein the request from the Anchor MSCe to place the Target MGW resources in an active state and to instruct the Target MGW resources to set up a bearer connection to the B-Party is a Session Initiation Protocol (SIP) re-INVITE containing a Session Description Protocol (SDP) Offer that originated from the B-Party.
